(19) United States
(12) Patent Application Publication
(10) Pub. No.: US 2025/0226610 A1
(43) Pub. Date: Jul. 10, 2025

(54) CONNECTOR ASSEMBLY AND METHOD OF ASSEMBLING A CONNECTOR ASSEMBLY

(71) Applicant: Aptiv Technologies AG, Schaffhausen (CH)

(72) Inventors: Norbert DOBERNIG, Lauf (DE); Nithish SUKUMAR, Tamil Nadu (IN)

(21) Appl. No.: 19/008,826

(22) Filed: Jan. 3, 2025

(30) Foreign Application Priority Data
Jan. 5, 2024 (IN) 202441000935

(51) Int. Cl. H01R 13/506; H01R 43/18

(52) U.S. Cl. CPC H01R 13/506; H01R 43/18; H01R 2201/26

(57) ABSTRACT

A connector assembly includes a connector with a first housing part, a second housing part, and a terminal holder within the first housing part. At least one terminal is housed in the terminal holder, featuring a contact portion designed to connect with a terminal in a counterpart connector, extending primarily in the mating direction. The second housing part is mountable with the first housing part through at least one mounting displacement parallel to the mating direction. It includes an actuating portion, while the terminal holder has a wedge portion configured for partial insertion between the first housing part and the terminal holder. The actuating portion presses on the wedge portion during mounting, and the terminal holder and wedge portion are designed to prevent movement parallel to the mating direction between the first housing part and the terminal holder when the wedge portion is engaged by the actuating portion.

### CROSS-REFERENCE TO RELATED APPLICATION

This application claims the benefit of and priority to Indian Patent Application number 202441000935 filed on Jan. 5, 2024, the contents of which are incorporated by reference herein.

### TECHNICAL FIELD

The present disclosure relates a connector assembly and method of assembly for use in fastening together parts of automotive connectors.

### BACKGROUND

Certain types of connector assembly can accommodate electrical terminals which are electrically connected to a printed circuit board. In this case, the assembly of the terminals on the printed circuit board, the assembly of the printed circuit with its terminals on a terminal holder and the assembly of the whole connector are operations that can be conducted on separate assembly lines, or even by different suppliers. These various assemblies can generate constraints that make it necessary to avoid rigid fixing of parts of the connector. For example, it may be advantageous to clamp a terminal holder between two die-cast housing parts. As a result, the terminals of the assembled connector may not overlap as well with the contacts of a counter-connector. A solution is therefore needed to solve this problem.

The following disclosure relates to a connector including a PCB carrier or holder but is not limited to such a configuration. Terminals can be mounted on a terminal holder and connected to conductive elements (wires, busbars, etc.) without the need for a PCB.

Whatever the case may be, depending on the configuration of the connector assemblies, a problem of relative movement between a terminal holder and a housing part may arise. Such a relative movement can be, in particular, detrimental to the quality and reliability of the electrical contact between the terminals of a connector and of a counter-connector configured to be mated to the connector. In addition, the total load resulting from the mating sequence (female connector with male connector) is subject to the risk of being applied to the soldering area of the PCB terminals.

### SUMMARY

A connector assembly and method of assembling such a connector assembly that at least partially meet the requirements of modern assembly processes are disclosed below.

The present disclosure relates to a connector assembly including a connector. The connector is intended to be mated and electrically connected to a counterpart connector. For example, the connector is a male connector, and the counterpart connector is a female connector (but it can also be the other way round). For example, this male connector is a header. The connector includes a first housing part, a second housing part and a terminal holder accommodated in the first housing part. At least one terminal is accommodated in the terminal holder. The at least one terminal has a contact portion configured to be connected to a terminal accommodated in the counterpart connector. For example, the contact portion extends essentially in a mating direction of the connector with the counterpart connector. The second housing part is configured to be mounted with the first housing part with at least one mounting displacement of the second housing part relative to the first housing part, parallel to the mating direction. In other words, the second housing part is mounted with the first housing part with a displacement relative to each other, this displacement having at least one component parallel to the mating direction.

Furthermore, the second housing part includes an actuating portion, and the terminal holder includes a wedge portion. The wedge portion is configured to be at least partially inserted between the first housing part and the terminal holder. The actuating portion is configured to press on the wedge portion when the second housing part is mounted with the first housing part, along the mounting displacement. The terminal holder and the wedge portion are configured to block a movement parallel to the mating direction between the first housing part and the terminal holder when the wedge portion is pushed by the actuating portion.

The features above have the advantages that:
they enable the relative movement between the terminal holder and the second housing part to be cancelled when it is not appropriate to use rigid fixation means (screwing means, locking means, etc.) to mount the terminal holder in the second housing part, before assembly with the first housing part (even in the case of unavoidable clearances due to the manufacturing tolerances);
they enable cancelling the movement in the mating direction between the first housing part and the terminal holder and as a consequence the enable a more precise and reliable relative positioning of the connector and counter-connector terminals;
they are easy to implement;
they can be cost effective, as no sliders are required for injecting molding these features; and
they can be implemented in various configurations and designs; etc.

According to an embodiment, the actuating portion has a beam-like shape extending longitudinally parallel to the mating direction. Such an actuating portion has therefore a simple shape, which is easy to mould, and which can be robust.

According to an embodiment, the terminal holder includes a base portion, and a flexible leg linked to the base portion by a hinge at one end. The terminal holder includes the wedge portion at another end. The flexible leg includes a ramp configured so that that the actuating portion interacts with the ramp and the flexible leg rotates about the hinge when the second housing part is mounted with the first housing part, along the mounting displacement. For example, the flexible leg is thinner in the vicinity of the hinge than in the vicinity of the wedge portion. For example, the wedge portion includes at least one first wedge and at least one second wedge, both projecting at the free end of the flexible leg, in a direction essentially perpendicular to the mating direction. For example, the actuating portion is engaged in a channel essentially parallel to the mating direction, and the first wedge projects at a mouth of the channel. With such a configuration, it is possible not to use sliders for moulding the terminal holder.

According to an embodiment, the actuating portion and the wedge portion are configured so that the actuating portion pushes a first side of the wedge portion against the first housing part and a second side of the wedge portion against the terminal holder.

According to an embodiment, the first wedge includes a first friction surface having a convex shape. Such a configuration enables a robust Wedge Friction Lock. This locking function (in addition to the locking function provided by the interaction of second side of the wedge portion against the terminal holder) also ensures the correct position of the wedge between the first housing part, the second housing part and the terminal holder, even if the flexible leg is damaged or broken.

According to an embodiment, the connector assembly is configured so that any movement in the mating direction of the terminal holder relative to the first housing part is controlled only by interaction of the actuating part with the wedge portion.

According to another aspect, it is disclosed below a method for assembling a connector including at least the following steps:
mounting the terminal holder in the first housing part an insertion direction;
mounting the second housing part with the first housing part; and
mounting the connector with a counter-connector parallel to a mating direction, thereby pushing the second housing part in the mating direction and pushing the actuating portion against the wedge portion so as to pivot the wedge portion to press a first side of the wedge portion against the first housing part and a second side of the wedge portion against the terminal holder.

According to an embodiment, the insertion direction is perpendicular to the mating direction.

### BRIEF DESCRIPTION OF THE DRAWINGS

Exemplary embodiments and functions of the present disclosure will be described in more detail in the following with reference to the drawings showing in:

FIGS. 1 and 2 are exploded perspective views of a connector assembly according to some embodiments.

FIG. 3 is a perspective view of the terminal holder of the connector assembly shown in FIGS. 1 and 2 according to some embodiments.

FIG. 4 shows an elevation view of part of the terminal holder shown in FIG. 3 according to some embodiments.

FIG. 5 is a perspective view of the wedge portion of the terminal holder shown in FIGS. 3 and 4 according to some embodiments.

FIGS. 6 and 7 are lateral views of the wedge portion of the terminal holder shown in FIGS. 3 and 4, as well as portions of the first housing part and the second housing part, with which the wedge portion interacts according to some embodiments.

FIG. 8 is a perspective view of the example of embodiment of a connector assembly shown in FIGS. 1 and 2, with the first housing part the second housing part and the terminal holder being assembled according to some embodiments.

### DETAILED DESCRIPTION

This disclosure relates to a connector assembly 100 (see FIG. 8). This connector assembly 100 includes at least a connector 10. The connector assembly 100 can also include a counter-connector (not illustrated). The connector 10 is then configured to mate with the counter-connector. For example, the connector 10 is a male connector. For example, this male connector 10 is a header. The connector 10 includes at least a first housing part 1, a second housing part 2 and a terminal holder 3. For example, the first housing part 1 is a die-cast housing. For example, this die-cast housing is part of a power box. For example, the second housing part 2 is a header shroud. For example, the second housing part 2 is a moulded plastic part.

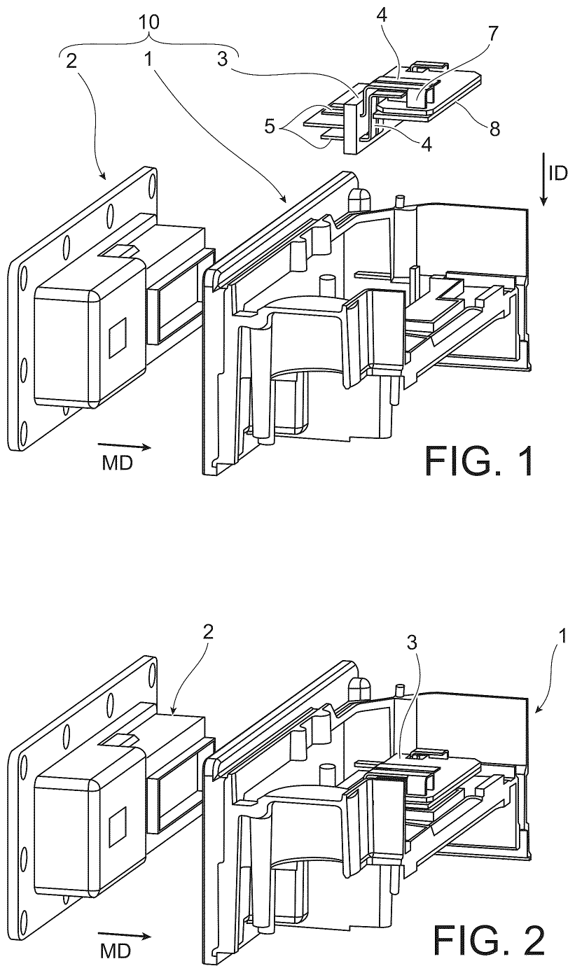

The terminal holder 3 is also called pin block. The terminal holder 3 is made of a dielectric material. For example, the terminal holder 3 is a moulded plastic part. At least one terminal 4 is accommodated in the terminal holder 3 (see FIG. 1). Possibly, the terminal holder 3 supports several terminals 4. Each terminal 4 maintained by the terminal holder 3 is made of an electrically conductive material. For example, each one of these terminals 4 is made as a male terminal cut from a sheet of conductive material and bent so as to have a contact portion 5 configured to be connected to a female terminal accommodated in the counterpart connector. This contact portion 5 extends essentially in a mating direction MD of the connector 10 with the counterpart connector. For example, at least one, or each one, of these terminals 4 is stitched in the terminal holder 3. Alternatively, the terminal holder 3 is overmolded over at least one, or each one, of these terminals 4. Alternatively, at least one, or each one, of these terminals 4 is simply inserted in an opening 6 made in the terminal holder 3 (see FIG. 4). For example, each one of these terminals 4 extends between the contact portion 5 and a connecting portion 7 (see FIG. 1). For example, the connecting portion 7 is soldered to a PCB 8. The contact portion 5 extends essentially parallel to the mating direction MD. Therefore, when the male connector 10 is mated to a female counter-connector, it is essential that the insertion force between the male and female terminals is not transmitted, or not fully transmitted, at the solder joints on the PCB 8.

The terminal holder 3 is mounted in the first housing part 1 with the terminals 4 and the PCB 8 (see FIGS. 1 and 2). For example, the terminal holder 3 is mounted in the first housing part 1 in an insertion direction ID which is perpendicular to the mating direction MD.

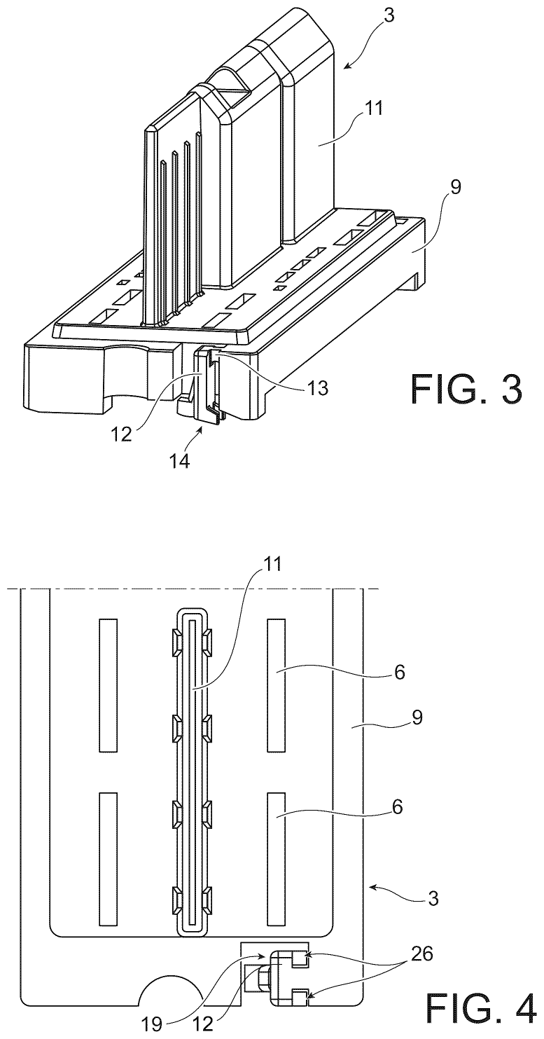

As illustrated in FIGS. 3 to 5 in particular, the terminal holder 3 includes a base portion 9 and an insulating wall 11. The base portion 9 has essentially a plate-like shape extending perpendicular to the mating direction MD (when the terminal holder 3 is mounted in the first housing part 1). The openings 6 are made through the base portion 9. The wall 11 extends perpendicular to the base portion 9.

The terminal holder 3 also includes wedge means. The terminal holder 3 can include one or several wedge means (for example, at opposite corners or end sides of the base portion 9). For example, each wedge means includes at least one flexible leg 12. Each flexible leg 11 extends essentially parallel to the mating direction MD (when the terminal holder 3 is mounted in the first housing part 1), between a hinge 13 and a wedge portion 14. Each hinge 13 joins a flexible leg 12 to the base portion 9. More particularly, each flexible leg 12 extends from a respective hinge 13, in a direction opposite to the wall 11. In other words, each flexible leg 12 extends from a first side of the base portion 9 from which the wall 11 extends, to a second side of the base portion 9, opposite the first side, the wedge portion 14 projecting at least partially on the second side. The length of the flexible leg 12 is longer that the thickness of the base portion 9.

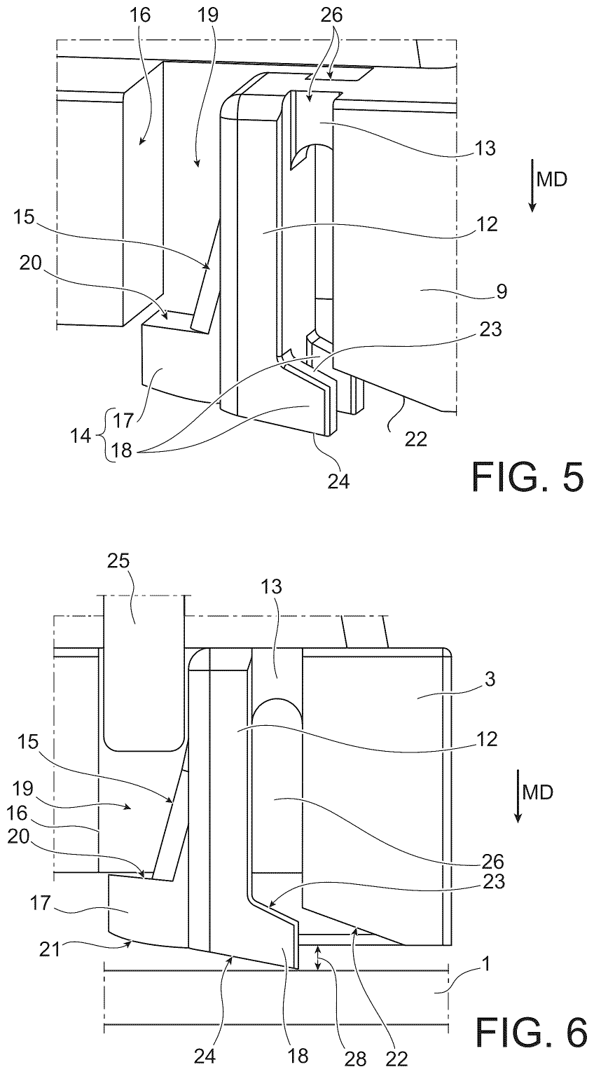

Each flexible leg 12 includes a slanted ramp 15 configured so that the flexible leg 12, seen in cross section in a plane perpendicular to the wall and parallel to the mating direction MD (see FIG. 5), is thinner in the vicinity of the hinge 13 than in the vicinity of the wedge portion 14. Advantageously, the terminal holder 3 includes a guiding wall 16 facing the ramp 15. Advantageously, the distance between the flexible leg 12 and the guiding wall 16 in line with the hinge 13 (in a direction perpendicular to the mating direction MD) is larger than towards the wedge portion 14. For example, the guiding wall 16 extends in a plane parallel to mating direction MD, while the ramp 15 makes an angle with the mating direction MD.

The wedge portion 14 includes at least one first wedge 17 and at least one second wedges 18. In the illustrated example, the wedge portion 14 includes one first wedge 17 and two second wedges 18 (see FIG. 5).

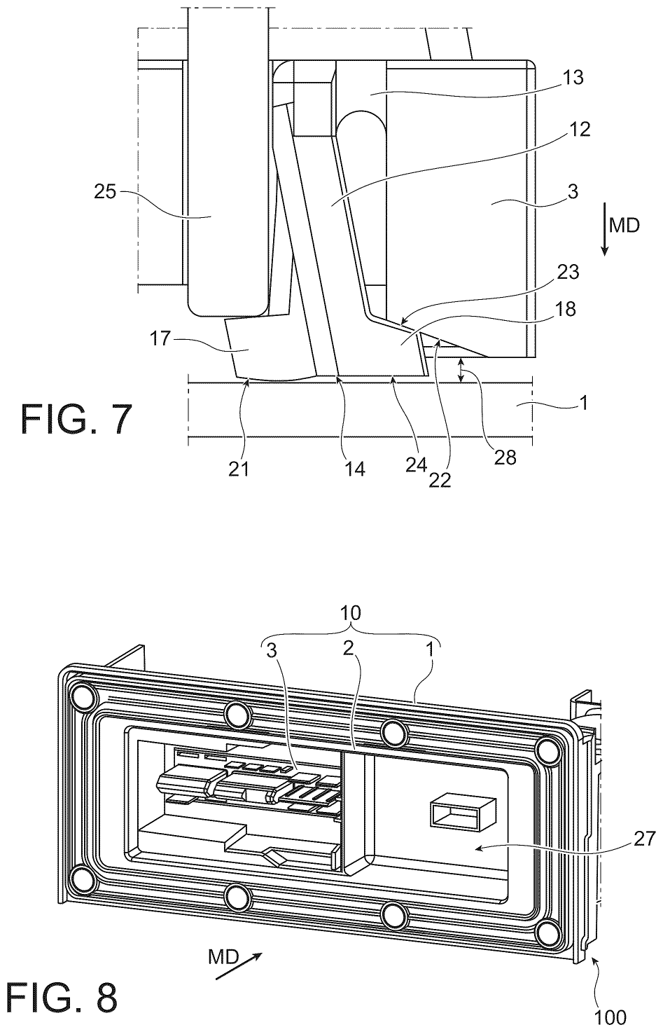

The first wedge 17 projects at the free end of the flexible leg 12, below the ramp 15, in a direction opposite to the second wedges 18. In other words, the first wedge 17 projects in a channel 19, at the end of a channel or at the mouth of the channel 19, at least partially delimited by the flexible leg 12 and the guiding wall 16. In the illustrated example, the first wedge 17 projects at the mouth of the channel 19. The first wedge 17 includes a blocking surface 20 facing an outlet of the channel 19. In the illustrated example, the blocking surface 20 at least partially closes the mouth of the channel 19. The blocking surface 20 forms an angle less than or equal to 90° with the longitudinal direction of the flexible leg 12 and more than 90° with the ramp 15 (see FIG. 6). When the flexible leg 12 is not flexed, the blocking surface 20 forms an angle greater or equal to 90° with the guiding wall 16. When the flexible leg 12 is fully flexed, the blocking surface 20 forms an angle less than or equal to 90° with the guiding wall 16 (see FIG. 7). The first wedge 17 also includes a first friction surface 21. Advantageously, the first friction surface 21 has a convex shape with a curvature directed essentially in the direction of the channel 19.

Each second wedge 18 extends in a gap 28 located between the terminal holder 3 and the first housing part 1. The terminal holder 3 includes a slanted surface 22. When the flexible leg 12 is not flexed, the slanted surface 22 is offset, in a plane perpendicular to the mating direction MD, from the second wedge 18 (see FIG. 6). When the flexible leg 12 is flexed, the second wedge 18 comes below the slanted surface 22, in the gap 28 between the slanted surface 22 and the first housing part 1 (see FIG. 7).

Each second wedge 18 includes a second friction surface 23. This second friction surface 23 forms an angle of greater or equal to 90° with the longitudinal direction of the flexible leg 12. The flexible leg 12 can be flexed up to a position in which the friction surface 23 is pushed against the slanted surface 22. Each second wedge 18 also includes a bottom surface 24 directed towards the first housing part 1.

The second housing part 2 includes at least one actuating portion 25 (see FIGS. 6 and 7). For example, the second housing part 2 includes as many actuating portions 25 as there are wedge means. In the illustrated example, the actuating portion 25 has a beam shape extending longitudinally parallel to the mating direction MD. The shape of each actuating portion 25 is adapted to penetrate and slide into a respective channel 19. The thickness of the actuating portion 25 is greater than the smallest dimension of the channel 19 in a direction perpendicular to the guiding wall 16 (with reference to FIGS. 6 and 7).

One can note that the channel 19 and two other channels 26 (see FIGS. 4 and 5) can be used for moulding the flexible leg 12 as well as the first and second wedges 17, 18 without using additional moulding sliders. Therefore, the manufacturing process of the connector assembly 100 according to this disclosure remains cost effective.

The assembly process of the connector assembly 100 according to this disclosure includes, for example, at least the following steps:
mounting the terminal holder 3 in the first housing part 1; for example, the terminal holder 3 is inserted in the first housing part 1 along the insertion direction ID (see FIG. 1);
mounting the second housing part 2 onto the first housing part 1 (See FIG. 2); for example, the second housing part 2 is inserted in the first housing part 1 along mounting direction which is parallel to the mating direction MD, so as to form a connector 10; and
mounting the connector 10 with a counter-connector (not shown).

For example the counter-connector includes a die-cast part which is mounted against a die-cast part (the first housing part 1) of the connector 10; by doing so the window 27 (see FIG. 8) is closed and the second housing part 2 is pressed and maintained inside the first housing part 1; in other words, the second housing part 2 is mounted with the first housing part 1 with at least one mounting displacement of the second housing part 2 relative to the first housing part 1, parallel to the mating direction MD; by doing so, at least one actuating portion 25 is pushed, in the mating direction MD, in a respective channel 19 (see FIG. 6); as a consequence, each actuating portion 25 slides along a respective ramp 15; each flexible leg 12 is then flexed and the corresponding second wedge 18 is moved below a slanted surface 22, while the first friction surface 21 comes in contact with the first housing part 1 (see FIG. 8); as the first friction surface 21 is convex if the actuating portion 25 presses the blocking surface 20 on an appropriate side of the point of contact between the first friction surface 21 and the first housing part 1, the first wedge 17 tends to rotate so as to push the second friction surface 23 against the slanted surface 22; in other words, when the connector 10 is mounted with a counter-connector, the counter-connector pushes the second housing part 2 in the mating direction MD and thereby pushes the actuating portion 25 against the wedge portion 14 so as to pivot the wedge portion 14 to press one side of the wedge portion 14 against the first housing part 1 and an another side of the wedge portion 14 against the terminal holder 3; one can note that even if the flexible leg 12 breaks the wedge function of the wedge portion 14 remains effective.

As result of the assembly process described above, the movement, in the mating direction MD, of the terminal holder 3 relative to the first housing part 1 is cancelled. In other words, the gap 28 between the terminal holder 3 and the first housing part 1 is compensated. Any movement in the mating direction MD of the terminal holder 3 relative to the first housing part 1 is controlled only by interaction of the actuating part 25 with the wedge portion 14, i.e. such movement is not controlled by a screwing means, latching means or the like. Further, the movement, in the mating direction MD, of the second housing part 2 relative to the terminal holder 3 and the first housing part 1 is cancelled too.

One can note, that even if the claimed invention is exemplified and illustrated with a first housing part 1 being a die-cast housing and the second housing part 2 being a header shroud, the invention can be used in other kinds of connector assemblies in which a gap needs to be compensated.

The connector assembly above-disclosed has the advantage that it increases the contact overlap between the respective terminals of the connector 10 and the counter-connector. The invention has also the advantage of decreasing or cancelling the relative movement between the terminal holder 3 and the PCB 8 (this preserves the solder joints between terminals and the PCB).

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. A connector assembly, comprising:
a connector having a first housing part, a second housing part and a terminal holder accommodated in the first housing part, at least one terminal being accommodated in the terminal holder, the at least one terminal having a contact portion configured to be connected to a terminal accommodated in a counterpart connector, the contact portion extending essentially in a mating direction of the connector with the counterpart connector, the second housing part being configured to be mounted with the first housing part with at least one mounting displacement of the second housing part relative to the first housing part, parallel to the mating direction, the second housing part comprising an actuating portion and the terminal holder comprising a wedge portion, the wedge portion being configured to be at least partially inserted between the first housing part and the terminal holder, the actuating portion being configured to press on the wedge portion when the second housing part is mounted with the first housing part, along the mounting displacement, and the terminal holder and the wedge portion being configured to block a movement parallel to the mating direction between the first housing part and the terminal holder when the wedge portion is pushed by the actuating portion.

2. The connector assembly according to claim 1, wherein the actuating portion has a beam-like shape extending longitudinally parallel to the mating direction.

3. The connector assembly according to claim 1, wherein the terminal holder comprises a base portion and a flexible leg linked to the base portion by a hinge at one end and comprises the wedge portion at another end, and wherein the flexible leg comprises a ramp configured so that that the actuating portion interacts with the ramp and the flexible leg rotates about the hinge when the second housing part is mounted with the first housing part, along the mounting displacement.

4. The connector assembly according to claim 3, wherein the flexible leg is thinner in a vicinity of the hinge than in the vicinity of the wedge portion.

5. The connector assembly according to claim 3, wherein the wedge portion comprises at least one first wedge and at least one second wedge, both projecting at a free end of the flexible leg, in a direction essentially perpendicular to the mating direction.

6. The connector assembly according to claim 5, wherein the first wedge comprises a first friction surface having a convex shape.

7. The connector assembly according to claim 5, wherein the actuating portion is engaged in a channel essentially parallel to the mating direction, and the first wedge projects at a mouth of the channel.

8. The connector assembly according to claim 1, wherein the actuating portion and the wedge portion are configured so that the actuating portion pushes a first side of the wedge portion against the first housing part and a second side of the wedge portion against the terminal holder.

9. The connector assembly according to claim 1, configured so that any movement in the mating direction of the terminal holder relative to the first housing part is controlled only by interaction of the actuating part with the wedge portion.

10. A method of assembling a connector, comprising:
mounting a terminal holder in a first housing part in an insertion direction;
mounting a second housing part with the first housing part; and
mounting the connector with a counter-connector parallel to a mating direction thereby pushing the second housing part in the mating direction and pushing an actuating portion against a wedge portion so as to pivot the wedge portion to press a first side of the wedge portion against the first housing part and a second side of the wedge portion against the terminal holder.

11. The method according to claim 10, wherein the insertion direction is perpendicular to the mating direction.

12. The method according to claim 10, wherein the second housing part is configured to be mounted with the first housing part with at least one mounting displacement of the second housing part relative to the first housing part, parallel to the mating direction, wherein the second housing part comprises an actuating portion and the terminal holder comprises a wedge portion, the wedge portion being configured to be at least partially inserted between the first housing part and the terminal holder, wherein the actuating portion is configured to press on the wedge portion when the second housing part is mounted with the first housing part, along the mounting displacement, and wherein the terminal holder and the wedge portion are configured to block a movement parallel to the mating direction between the first housing part and the terminal holder when the wedge portion is pushed by the actuating portion.
